(19) United States
(12) Patent Application Publication
(10) Pub. No.: US 2007/0227754 A1
(43) Pub. Date: Oct. 4, 2007

(54) Insulating Electricity Distribution Systems

(75) Inventor: Ferghal McEvatt, Glenageary (IE)

Correspondence Address: THE WEBB LAW FIRM, P.C., 700 KOPPERS BUILDING, 436 SEVENTH AVENUE, PITTSBURGH, PA, 15219, US

(73) Assignee: CANATO LIMITED, BLUEBELL (IE)

(21) Appl. No.: 11/597,002

(22) PCT Filed: May 17, 2005
(86) PCT No.: PCT/IE05/00057

§ 371 Date: Nov. 17, 2006

(30) Foreign Application Priority Data
May 18, 2004 (IE) S2004/0348

(51) Int. Cl. H02B 1/06

(52) U.S. Cl. 174/5 R

(57) ABSTRACT

A shroud barrier is provided for shrouding an electricity distribution system to and to mounted on a substrate. The system includes a support for supporting an electrical distribution panel on a substrate and an electrical distribution panel on the support. The distribution panel includes at least one busbar arranged on the support and at least one pair of spaced apart fuse contacts each having a free end, with the free ends thereof adapted to receive a fuse. One fuse contact is connected to the busbar and the other is connected to an outlet point. The fuse contacts are arranged so that the free ends thereof hold the fuse away from the busbar. The shroud barrier includes a sheet of insulating material slotted so as to slidingly fit across the fuse contacts, and dimensioned to cover the busbar and the support, so that substantially only the free ends of the fuse contacts extend through the slot.

### FIELD OF THE INVENTION

The present invention relates to the field of insulating electricity distribution systems (apparatuses or arrangements) such as electricity distribution stations such as those which are commonplace. Of particular interest are electricity distribution systems which take in power at a voltage supplied across high-tension lines from a power supply station and output electricity at a voltage suitable for supply to an end user such as a domestic or commercial user. Such distribution systems are often referred to as electricity (sub) stations (or as a high voltage to low voltage electrical station). They are often housed either in a relatively small building or a floor-mounted container located in close proximity to a traffic network, such as a road or a street, and may even be of a size suitable for mounting on a pole. The latter are typically referred to as being mounted in a box. Of particular interest are all aspects of insulating, including component parts, kit, materials and methods of insulating such systems.

### BACKGROUND TO THE INVENTION AND DESCRIPTION OF RELATED ART

Electricity distribution systems are known. Typically they are provided on a support, which is fixed to a substrate. In the case of a system provided within a building, one or more walls of the building provide the substrate to which the support is fixed. The support itself is generally a mounting frame. The mounting frame may or may not be insulated from the substrate. Furthermore the mounting frame itself may be conductive in which case it is also live at the same voltage as the busbar(s).

It will be appreciated that such distribution systems or panels are extremely hazardous. They often run very high voltages. The intake of those distribution panels of can take in electricity at a voltage of 10,000 V or even greater. Accordingly, the risk of serious injury or death from contact with either the distribution panel itself, or its underlying support frame, or indeed any of its supply intake or output components can be extremely high. Even though the voltage in an output from such a distribution panel may be substantially stepped down, it was still represents a potential hazard.

Typically an operator working on such a distribution panel, in a live environment, needs to be wearing protective gear, stand on an insulating mat, and needs to follow very stringent procedures. Because most consumers are intolerant of a break in their supply of electricity, many operations in relation to maintenance of, updating and increasing capacity of such distribution panels is done in a live environment. Each year injuries and deaths occur as a result of accidents with such distribution panels, where an operator inadvertently comes into contact with the high voltage electricity supply. Severe burns and/or deaths occur from even the most incidental contact.

Generally the only protection against electrocution from such a panel is provided by the building, container or box in which the panel is kept. This does of course protect those who do not have access to the interior of the building or the box from exposure to the dangers of the high voltage within. Within the building or box, the components of the panel are however generally exposed, (i.e. non-insulated) such that the dangers are immense for operators who need to access the panel directly.

There is a need therefore for a way to protect against electrocution from such electricity distribution panels, particularly in a live environment.

European patent application number EP 1 403 989 A1 (ABB Service S.r.l.) discloses an electrical cabinet made of panel elements. The cabinet is for an electricity switchboard. A protective hood for an electrical connection cabinet is described in the Esp@cenet English language abstract for FR 2625620. Another cabinet type arrangement is described in the Esp@cenet English language abstract for ES 2,063,888T (Kloeckner Moeller GmbH).

U.S. Pat. No. 5,824,948 (Berg) describes a safety shield for preventing accidental shorting. The Esp@cenet English language abstract for JP 9172706 (Mitsubishi Electric Corp.) describes an insulating component for placing over the terminal part of a component in a distribution panel. The Esp@cenet English language abstract for DE 3,409,569 (Arcus Elektrotech) describes an insulating panel, which can be placed on guide rails the for protection of a person from shocks from the upper space of a switching cell.

Other prior art documents such as Canadian patent application no. CA 1,065,939 (Westinghouse Electric Corp.), describe insulated busbars by providing a cover (barrier) directly about the busbar(s).

Notwithstanding the various arrangements set out in these prior documents, there is still a need for protection of operators working on a live distribution panel from shocks. In particular there is a need for making existing electricity distribution systems relatively safe for operators to work with.

The various aspects of the present invention provide a solution to the problems outlined above.

### SUMMARY OF THE INVENTION

In its broadest aspect the present invention relates to a method of shrouding an electricity distribution system comprising:
electricity carrying elements provided on a support, and which electricity distribution system comprises certain electricity carrying elements proximate to the support and with the support and/or certain electricity carrying elements extending away from the support in an access direction,
   the method comprising, the step of slidingly fitting a sheet of insulating material dimensioned to shroud at least selected ones of the electricity carrying elements proximate to the support, to the support and/or electricity carrying elements extending away from the support, so as to form a barrier preventing access to the at least selected ones of the electricity carrying elements proximate to the support. The invention relates to a shroud comprised of insulating material slotted for use in such a method.

More particularly the present invention relates to a shroud barrier for shrouding an electricity distribution system mounted on a substrate:
the system comprising:
   (i) a support for supporting an electrical distribution panel on a substrate;
   (ii) an electrical distribution panel on the support, the distribution panel comprising:
      at least one busbar arranged on the support;
      at least one pair of spaced apart fuse contacts each having a free end, the free ends thereof adapted to receive a fuse, one fuse contact connected to the busbar and the other connected to an outlet point, the fuse contacts arranged so that the free ends thereof hold the fuse away from the busbar;
         the shroud barrier comprising a sheet of insulating material slotted so as to slidingly fit across the fuse contacts, and dimensioned to cover the busbar and the support, so that substantially only the free ends of the fuse contacts extend through the slot.

In this respect the shroud is generally supported by being fitted over the fuse contacts. It will generally remain in place without the necessity for further fixing i.e. self-supporting. It can be arranged to sit on the busbars or otherwise support itself. It can be considered a sliding fit to the distribution system. In this respect it will generally be arranged to stand in a substantially upright position, therefore substantially vertically. However, if the busbar(s) are provided in a substantially horizontal arrangement, for instance along a ceiling or floor portion, it may be arranged substantially horizontally.

The shroud may be fitted by sliding over the free ends (by fitting over the free ends) of the fuse contacts and along the fuse contacts and being moved along (generally down) the fuse contacts until the shroud panel clears the fuse receiving part of the free ends. In this arrangement the slots are provided in the form of apertures in the shroud arranged to mate with the fuse contacts can be employed.

However it is generally desirable that the shroud can be fitted without the need to remove the fuses and/or any fuse cover that might be present. If the fuse covers remain in place larger apertures may be required which may increase exposure/reduce the area shrouded. If only the fuse contacts were present then apertures required would be much smaller.

In any event, in all arrangements of the invention it is desirable that the slot(s) are dimensioned to be a close fit with the contacts so that the maximum shrouding is achieved.

An alternative arrangement is to provide the shroud with one or more slots that run from one edge of the panel inwardly (the slot opens out on one side of the panel and runs to a desired point toward an opposite edge of the panel). In this arrangement the slot is arranged to be a sliding fit across both fuse contacts (of a given pair)—it acts as a receiver for the part. The sliding fit in this case is generally transverse to the (longitudinal axis of the) fuse contacts. This latter arrangement is particularly desirable as two or more pairs of fuse contacts may be arranged in a substantially linear configuration. In such a case a continuous slot can be arranged to slidingly fit over the substantially aligned pairs. Parallel slots are provided for fitting over laterally spaced apart (such as parallel rows of) contact pairs.

One particular advantage of the present invention is that such a slot can typically be quite narrow and can be dimensioned to be quite small so that unintended contact with any components by the physical barrier provided by the shroud barrier is quite difficult. In particular the slots may be sufficiently small to prevent access of a body part, such as a digit, through the slot to the obstructed components.

Another particularly important advantage is that a panel which has a slot which runs inward from its edge (as described above) can be slid into place while a fuse and/or fuse cover is in place. This means that the fuse does not need to be removed which in turn means that the electricity supply across the fuse contacts need not be interrupted for fitting of the shroud.

Furthermore, once this initial panel is in place, the danger of receiving an accidental shock is already greatly reduced, though the safety can be further improved as described below.

It will be appreciated by those skilled in the art that the panel will be a solid one and desirably form a continuous barrier. No breaks in that continuous barrier need be present. The person skilled in the art will appreciate where the sheet may be deliberately slotted, or otherwise modified to fit over/past a given component or other obstacle.

Generally however the sheet will be arranged so as to be (in the direction of ordinary access thereto) behind the fuse(s)/fuse cover(s) and in front of the underlying support/busbars. Generally it is desirable that only the fuse contacts extend from one side of the panel to the other so as to provide for maximum protection.

In certain arrangements of supply panels, there may be provided additional components for spare capacity. For example additional fuse contacts may be provided but these may be left unused, but nonetheless live. In any case it is desirable to provide a means for insulating any exposed fused contacts as these generally will protrude through the insulating panel. Additional length of busbars etc. may be shielded by use of an appropriately sized sheet.

In this respect the skilled person will appreciate that a series of sheets may be used to form a shroud arrangement. However for maximum safety, convenience and integrity of structure, where possible a (unitary) single sheet is preferred.

It will be appreciated by those skilled in the art that the sheet of material need not be a flat on one or both faces, as a sheet of varying thickness may be used if desired as the only constraint is that the sheet needs to fit, as described above, and further below, between inner and outer parts of the distribution construction. Having the sheet in a substantially planar form does however allow for insertion of the sheet into relatively constricted spaces, and is thus desirable. For example for sufficiently rigid materials a thickness of less than about 3 cm, such as less than about 2 cm and for example less than about 1 cm. Typical materials will have a thickness from about 3 mm to about 8 mm for example from about 5 to about 7 mm. The fuse contact cover of the present invention will be of similar dimensions.

In this respect it is also desirable to provide an electrical fuse contact cover for at least one pair of spaced apart fuse contacts each contact having a free end the free ends thereof arranged to receive a fuse, the cover having a body constructed of an insulating material with opposing side walls held in a spaced apart arrangement by an internal insulating spacer,
the walls forming a housing with a mouth therein, for the fuse contacts and the side walls being adapted to resiliently deform and grip the fuse contacts, and the spacer being profiled to extend about the free ends of the fuse contacts, when the cover is placed over the fuse contacts and the contacts are in the housing.

In this respect a single, slide-on cover is provided which can adequately protect any given pair of exposed fuse links.

It is desirable that the spacer extends into the space between contacts. This provides for a better fit to the contacts. Alternatively or additionally the spacer may mate with the free ends of the fuse contacts. For example the spacer may extend into the space between the pair of free ends. Alternative or additionally if the free ends each have a fuse receiving recess, as they typically have, the spacer may extend into any one or all of those recesses. The spacer is desirably a continuous unitary piece. It is suitably a solid piece but in the alternative may also be formed by one or more wall portions running within the housing. In this respect mating is not to be considered a close profile mating fit, as it is desirable to provide a contact cover that can fit similarly but not identically dimensioned fuse contacts which also may have variations on shape. In this respect extension of a male part on the spacer into a recess formed in, or a space between the fuse contacts, is considered sufficient for the purposes of the invention.

Desirably the contact cover comprises a handle portion for ease of handling.

Desirably the side-walls are profiled to form resiliently deformable jaws which act together to provide the gripping action. In this respect the mouth may be formed by the arrangement of the side-walls and for example absent any interconnection between the side walls about the mouth. The side-walls will generally be arranged to sufficiently close any gap between them to the sides of the mouth to prevent any unintentional contact.

The spacer and the side walls may all be made of separate pieces or integrally formed.

The fuse contact cover may also form part of a shroud of the present invention and is suitably fitted over a given pair of fuse contacts when the sheet is already in place.

It will be appreciated by those skilled in the art which materials may be used to provide a shroud as set out above. In particular the sheet is desirably substantially planar so that it can easily fit into the relatively confined space between the free ends of the contacts and the underlying components.

It may also be sufficiently rigid to stand upright unsupported. It will also generally be sufficiently impact resistant to withstand the force of a person falling against it and even a degree of resistance to mechanical forces applies by tools etc. This means that in all foreseeable accidental circumstances, for example a person who falls against or otherwise accidentally hits the shroud with a part of the body or an implement, will not generally puncture or break the shroud, so that while some damage may be caused to the shroud it would not generally be sufficiently extensive to expose a person to a risk of receiving a shock from the shrouded components.

The materials of which the shroud is constructed is desirably sufficiently insulating and non-conductive so that it can be placed into direct contact with (non-insulated) high voltage carrying elements without breaking down. Furthermore for longevity it is desirable that the material is also substantially non-hydroscopic.

It is also desirable than the sheet or as a sufficiently rigid support to allow other elements forming part of the shroud to be supported by it. In particular arcing of electrical current between adjacent current carrying elements is one of the most dangerous aspects of breaking of a high voltage current (for example by removal of a component). For example where a fuse is removed (utilising its fuse cover) from between its fuse contacts, arcing may occur from (one or both of the pair of) the now exposed fuse contacts to other parts of the system, and in particular other adjacent fuse contacts. For this reason it is desirable to provide at least one flash guard which will prevent arcing between adjacent current carrying elements.

For convenience, it is desirable that the flash guard(s) is (are) constructed of the same material as the sheet of material utilised to shroud the underlying components as described above. It is particularly desirable to provide flash guards between (pairs of) fuse contacts on a given busbar or on adjacent busbars. It will be appreciated by the person skilled in the art, that best practice would be that every possibility for arcing, would be eliminated. In this respect it is desirable that the flash guard is provided on the sheet so as to prevent arcing between adjacent (pairs of) fuse contacts.

In particular, where the (pairs of) fuse contacts are arranged in one or more rows, it is desirable to provide an elongate flash guard element which is attached to the sheet and runs between those rows. Each row may be provided on a single busbar or alternatively across adjacent busbars. Where an array of (pairs of) fuse contacts are provided (generally four or more pairs) it is desirable to provide flash guards which form a barrier to arcing from any given (pair of) fuse contacts to all adjacent (pairs of) fuse contacts. In particular, it is desirable to provide flash guards which act to provide a barrier in all directions about any given (pair of) fuse contacts.

Where the (usually at least four pairs of) fuse contacts are arranged in a matrix of rows and columns (generally respectively arranged horizontally and vertically), it is desirable to provide at least two flash guards which run transversely to each other and arranged so as to prevent arcing as between (pairs of) fuse contacts which are adjacent (next to) in a given row or column. Generally the rows and columns are substantially linear. However the flash guards of the present invention can be equally employed where the rows and columns are non-linear.

A skilled person will appreciate however, that if two or more elongate flash guards are used (in a generally parallel arrangement) to separate one column from another or one row from another, it may then be more practical to use (a series of) shorter flash guards to run between and transverse to the elongate flash guards.

It will be appreciated that the flash guard(s) of the invention may be integrally formed with the support sheet. However again, in particular for ease of retrofitting, it is desirable that the flash guard(s) are fitted after the sheet has been applied. Again this may be done in a live environment without high risk.

In general the flash guard(s) may be provided in a substantially L-shaped or U-shaped form. In the substantially L-shaped form the flash guard can be attached to the sheet by one limb of the L-shape while the other limb acts to provide a barrier against arcing. In a generally U-shaped form, the bridging portion (the bottom portion) of the U-shape can be employed to attach the flash character to the sheet. The opposing (upstanding) limbs of the U-shape (on the bridging portion) can each form a barrier against arcing (effectively then a double flash guard).

The shroud may thus further comprise substantially flat flash guard panels adapted to prevent arcing between adjacent pairs of fuse contacts.

In any event, it is also desirable to protect against access from any side (including where appropriate top and base ends) behind the shroud for example by insertion of a body parts such as the hand/digit, or an implement into any space left between the shroud and the underlying components. In this respect it is desirable to provide, as appropriate, one or more rear guards which extend rearwardly from the shroud towards the support to prevent (side) access to components shrouded. Generally it is desirable that the rear guard(s) would extend sufficiently proximate to the substrate to prevent such access. In particular it is desirable that the rear guard(s) extends from the shroud a sufficient distance to abut the substrate. In one particular aspect the rear guard(s) are formed on the sheet. In one very simple arrangement the rear guard(s) are formed by bending (in a generally rearwardly direction—toward the substrate) one or more portions of the sheet.

A further aspect of the invention relates to a construction of the material employed which is particularly desirable. In general it is desirable that the material can be bent, folded scored or cut so as to be shaped to a desired shape. In this respect it is desirable to have sheets of material which may be supplied in sheet form, but which may be easily worked on to provide the rear guard(s), and the flash guard(s) (for example U. shaped and L. shaped guards) as described above. The material may also be bent double (one side wall folded back upon on proximate itself so as to provide double side walls.

The present inventor has found that the use of a material having opposing side walls, the opposing side walls being connected by a series of (spaced apart) transverse members is particularly advantageous. A material with this arrangement may be considered a re-enforced or fluted (channeled) material. In particular it is desirable that the material is a plastics material which may be formed by extrusion. The transverse members may be linear walls (preferably continuous running along the length of the sheet). Alternatively the members may be of other shapes such as C. or B. shaped fluting.

The construction described above provides the advantage of having extra strength and rigidity. Such material will have desirable strength properties, which will act as an effective barrier in the situations described herein.

In respect of the fuse contact cover described above it may as described be formed as an integral piece or each piece may be separate and then assembled (such as by adhesive) in a structure with the spaced intermediate the side-walls. In either case it is desirable that the spacer itself is a fluted material, (such as described above) and that resiliently deformable side-walls are attached thereto, or the spacer is moulded with the spacer formed by a pattern of transverse members between the side walls. In either arrangement it is desirable that the transverse members are arranged generally perpendicularly to the direction of insertion of the fuse contacts.

On the other hand material of this construction may also be partially cut (scored) so that it may be easily folded. For example a cut (score) may be made through one side wall and (sufficient of the) transverse members so that the material can be folded about a fold line on the other side wall (generally the fold line will be in the same plane as the cut). It has been found that cutting in a direction across (as distinct from along) the transverse members gives a sharper cut. Of course the material may also be cut into separate pieces as required. The material should also be resistant to fracture upon folding.

It will be appreciated therefore that the rear guard on the sheet may be provided by forming a score-line proximate an appropriate edge on the sheet at the appropriate point to create a (hinged) rear guard portion and folding back the so-formed rear guard portion formed by creating the score line. It will also be appreciated that any number of scores may be provided at desired points in the material so that L-shape and U-shape pieces can also be easily constructed. In particular, such as with the rear guard portion, a further folding piece, may be provided and arranged to as to fold in an arrangement where a side wall of the material can be arranged substantially parallel to the support or substrate for fixing thereto.

It is also desirable to provide fasteners for fastening where required for example, the shroud to the support or substrate, the rear guard to the support or substrate, the flash guard(s) to the sheet or indeed at any other point where attachment of elements of the shroud is desired.

In this respect it is desirable to use fasteners which do not require the employment of electrically powered, or manually operated tools or implements. In particular self-adhesive fasteners are of particular interest. Within the category of self adhesive fasteners which are of interest are included materials which have two-part interengaging formations (each part self-adhering) such as self-adhering hook and loop fasteners (for example self-adhering Velcro™ sold by the company 3M) or the moulded two-part fastening product (also sold by 3M) under the product name Dual Lock™.

In this respect any given pieces can be fixed to the support or substrate, or to other parts of the shroud simply and easily.

The sheet is desirably substantially planar so that it can easily fit into the relatively confined space between the free ends of the contacts and the underlying components. It is also sufficiently rigid to stand upright unsupported. It will also generally be sufficiently impact resistant to withstand the force of a person falling against it and even a degree of resistance to mechanical forces applies by tools etc. This means that in all foreseeable accidental circumstances a person who falls against or otherwise accidentally hits the shroud with a part of the body or an implement will not generally puncture or break the shroud, so that while some damage may be caused to the shroud it would not generally be sufficiently extensive to expose a person to a risk of receiving a shock.

In this respect, the sheet can be considered as oversized in that it will be sized to extend beyond the perimeter of the area to be protected.

It will be appreciated that further elements such as a cover portion could be provided, for example to cover over the fuse cover(s). In this respect a cover could be easily fixed to the existing part of the shroud in any of the ways described above, for example by providing a side member between the cover and the existing shroud, attaching the cover portion to one or more of the sheet or one or more of the flash guards.

Furthermore any such cover, or indeed any part of the material may be provided with one or more window apertures, which may be located as desired in any part of the shroud. A substantially transparent window panel, also constructed of sufficiently impact resistant material (preferably plastics material) may be provided to cover any given aperture. It is desirable that the window is of substantially sufficient dimensions to prevent access, for example, by insertion of body parts such as the hand. The cover and/or the window panel may be attached in the manner described above. In this way the shroud can be built up as desired to form a housing for the entire arrangement to be covered. A cabinet type structure can be created in a retrofitting scenario.

The present invention also relates a method of shrouding an electricity distribution system as described above, comprising the steps of:
(i) providing a shroud barrier comprising a sheet of insulating material slotted so as to slidingly fit across the fuse contacts, and dimensioned to cover the busbar and the support; and
(ii) fitting the barrier over the fuse contacts so that substantially only the free ends of the fuse contacts extend through the slot.

The shroud may have the construction described above.

The method may also include the step of fitting one or more flash guards as described above. The method of the invention also includes providing one or more rear guards which extend from the shroud towards the support to prevent access to elements of the distribution panel which are shrouded by the sheet. The rear guard(s) may be provided by bending one or more portions of the sheet.

The invention also relates to a kit for assembling a shroud barrier as described above comprising:
(i) a shroud barrier comprising a sheet of insulating material slotted so as to slidingly fit across the fuse contacts, and dimensioned to cover the busbar and the support; and
(ii) two-part fastening means for fixing the barrier to at least one of the support, the distribution panel or the substrate.

Optionally the kit may further comprise one or more flash guards or include one or more rear guards.

### BRIEF DESCRIPTION OF THE DRAWINGS

FIG. 1 illustrates an electricity distribution station requiring isolation according to the present invention, including live bus bars to which fuses are connected by way of fuse contacts;

FIG. 2 provides an example of a shroud barrier configured according to the present invention in order to isolate the busbars shown in FIG. 1;

FIG. 3 shows the shroud of FIG. 2 being slidingly fitted to cover the busbars of FIGS. 1 and 2;

FIG. 4 shows the shroud of FIG. 3 slidingly fit, whereby only the free ends of the fuse contacts of FIGS. 1 and 3 extend through slots thereof;

FIG. 5 illustrates an alternative embodiment of the present invention, wherein the shroud of FIGS. 2 to 4 is configured with flash guards;

FIG. 6 provides another alternative embodiment of the present invention, wherein the flash guards of FIG. 5 have an alternative configuration;

FIG. 7 is a diagrammatic representation of an electrical fuse contact cover;

FIG. 8 illustrates the placing of the cover of FIG. 7 over fuse contacts of FIGS. 1 and 3 to 6 according to yet another embodiment of the present invention;

FIG. 9 is a diagrammatic representation of the electrical fuse contact cover shown in FIG. 8 in place over fuse contacts of FIGS. 1 and 3 to 6; and

FIG. 10 illustrates still another embodiment of the present invention, wherein the shroud barrier of FIGS. 2 to 6 and 8 and 9 is configured with a rear guard.

### DETAILED DESCRIPTION OF THE DRAWINGS

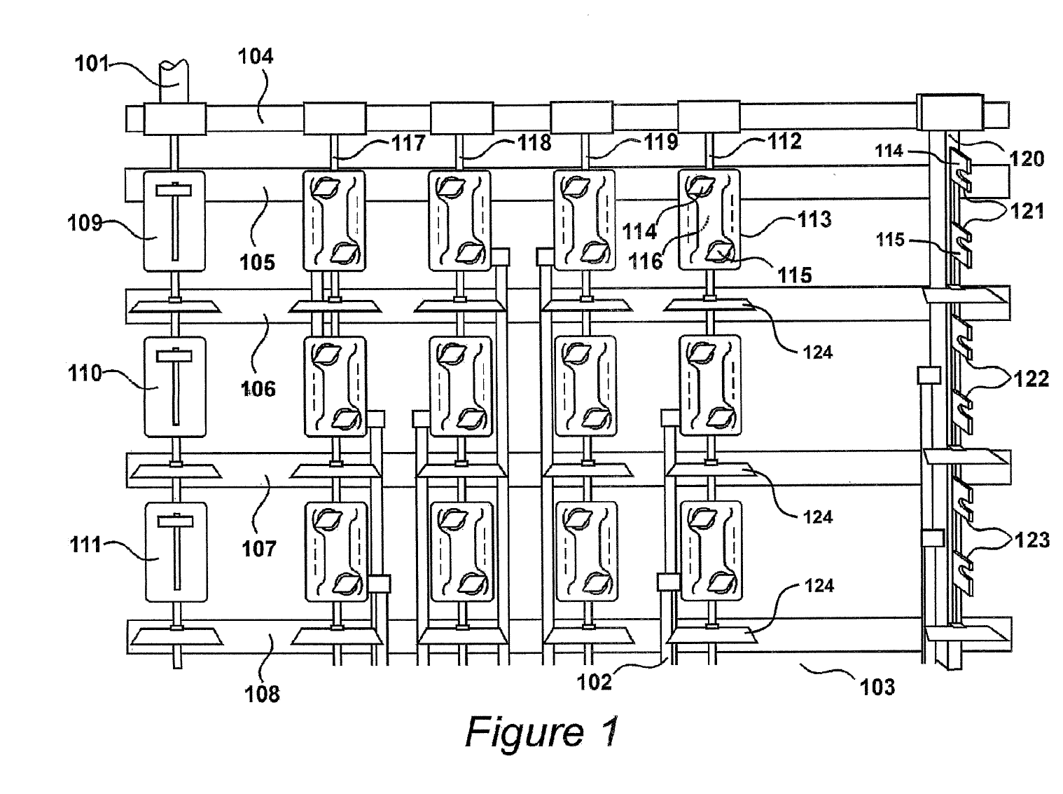

An electricity distribution system is shown in FIG. 1, as an electricity distribution station taking in power at a voltage of 10,000V supplied across high-tension lines 101 from a remote power supply station and outputting electricity across an electrical distribution panel to output lines 102 at a voltage of 220 V suitable for supply to an end user such as a domestic or commercial user.

One wall 103 of the building provides the substrate for support of a mounting frame 104. The mounting frame 104 is conductive at the same high-voltage of 10,000 V as the input lines 101 and is not insulated from the substrate, which is non-conductive. Generally mounted on the frame are a series of component parts of the distribution system, which will be referred here in as a “distribution panel”. The distribution panel will typically be held to the substrate 103 by the support frame 104. In general the distribution panel will comprise, at least one busbar 105 arranged on the support. Typically a number of busbars will be provided, usually a minimum of 3 or 4 busbars 105 to 108. Typically the busbars will be directly exposed to the high voltage of 10,000 V supplied across said lines 101. The busbars may be isolatable from the high voltage input by one or more isolating switches 109 to 111 provided in an arrangement sometime referred to as “trafo” links. The busbars are generally horizontal.

A line 102 or phase or a plurality thereof may be taken off a busbar 105, by way of coupling a fuse link 112 therebetween, wherein said fuse link includes at least one pair 113 of fuse contacts 114, 115 having respective free ends for connecting a fuse 116 thereto, said contact 114 being coupled to said busbar 105 and said contact 115 being coupled to said output point 102. Each of the fuse contacts 114, 115 preferably projects away from the busbar 105 and adapted to receive a fuse 116 can be held at a position spaced apart from the busbar 105. The fuse links are generally formed by flat pieces of conductive metal which have a typical width of about 4 mm to about 8 mm and more typically from about 5 mm to about 7 mm, such as from 5.8 to 6.5 mm. The fuse 116 acts as a step-down transformer between the 10,000 V-charged busbar 105 and the 220V output line 102.

In the example, four further fuse links 117 to 120 are provided, each of which is respectively configured with three pairs 113 of fuse contacts as previously described. However, the output of fuse link 120 is not yet required, for instance in order to increase the total output of the substation, thus its respective fuse contact pairs 121 to 123 do not hold any fuse 116 therein. The busbars-coupled fuse contacts of fuse pairs 121 to 123 respectively, do nonetheless carry a charge of 10,000V. Each of fuse links 112 and 117 to 120 are thus usually also configured with flash guards 124 located between each pair of fuse contacts in order to prevent electric arc forming between said (pairs of) contacts. The components 105 to 123 of the panel are exposed and non-insulated, such that the risk of serious injury or death from contact with either the distribution panel itself, or its underlying support frame 104, or indeed any of its supply intake 101 or output components 102 can be immense.

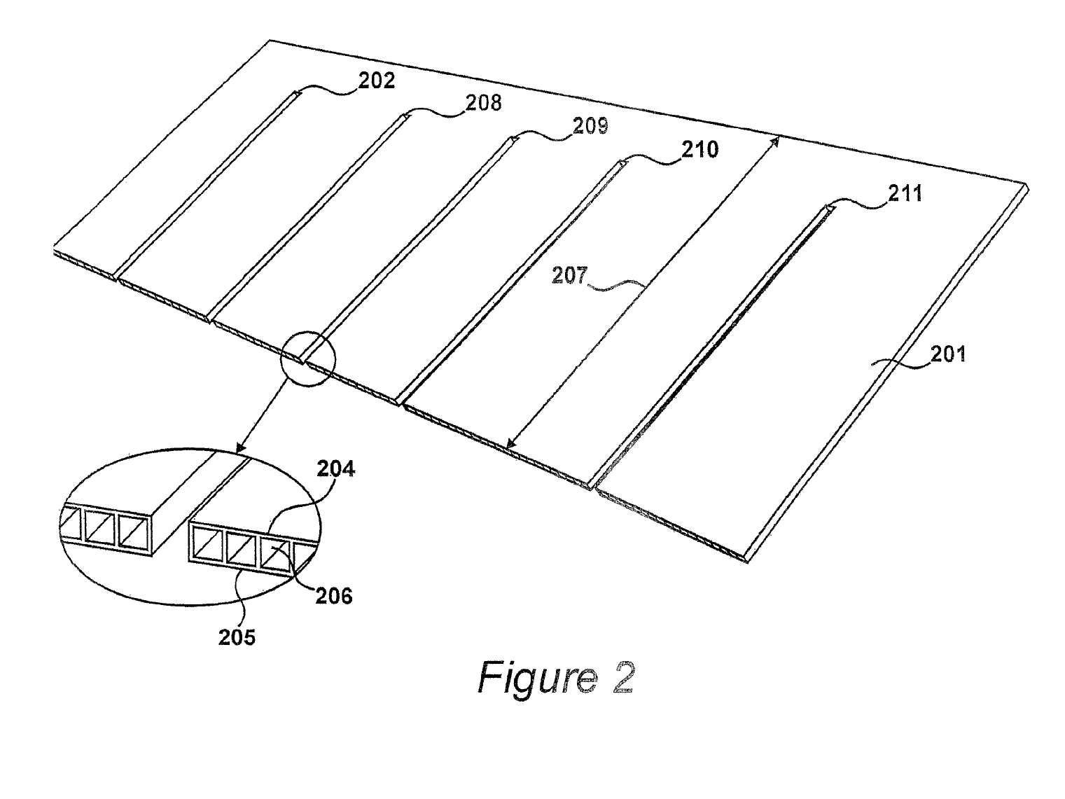

The corresponding need for protection of operators working on the live distribution panel shown FIG. 1 is addressed by the present invention by fitting a sheet of insulating material shown in FIG. 2, dimensioned to shroud at least selected ones of the electricity carrying elements 105 to 123 proximate to the support 104, so as to form a barrier preventing access to the at least selected ones of the electricity carrying elements 105 to 123 proximate to the support 104. The invention relates to a shroud comprised of insulating material 201 (see FIG. 2) slotted so as to slidingly fit across the fuse contacts 113, 121, 122 and 123, and dimensioned to cover the busbars 105 to 108 and the support 104, so that substantially only the free ends 114, 115 of each fuse contact 113, 121, 122 and 123 extend through one off slots 202; 208; 209; 210; 211.

Upon surveying and measuring the existing distribution panel, the material 201 to be utilised as the shroud may be cut to the appropriate size and shape, then slotted and/or scored as required. Simple equipment such as a folding table, measuring tape (non-conductive) and T-square may be employed. This first sheet will be used as a back panel 201 which will be positioned behind the fuses 113 and 121 to 123 to provide a base on which to optionally mount new flash guards, described further below.

It will be appreciated by those skilled in the art that the sheet of material 201 need not be flat on one or both faces, as a sheet of varying thickness may be used if desired as the only constraint is that the sheet needs to fit, as described above, and further below, between inner (104 to 112 and 117 to 120) and outer parts (113 to 115 and 121 to 123) of the distribution construction. Having the sheet in a substantially planar form does however allow for insertion of the sheet into relatively constricted spaces, and is thus desirable. For example for sufficiently rigid materials a thickness 203 of less than about 3 cm, such as less than about 2 cm and for example less than about 1 cm. Typical materials will have a thickness from about 3 mm to about 8 mm for example from about 5 to about 7 mm. The fuse contact cover of the present invention may be of similar dimensions.

The use of a material 201 having opposing side walls 204, 205, the opposing side walls being connected by a series of spaced transverse members 206, is particularly advantageous. A material with this arrangement may be considered a re-enforced, fluted or channeled material. In particular it is desirable that the material is a plastics material, which may be formed by extrusion. The transverse members define linear walls 206, which are continuous and run along the length 207 of the sheet. The configuration described above provides the advantage of having extra strength and rigidity. Such material will have desirable strength properties, which will act as an effective barrier in the situations described herein.

One such material 201 is the material sold under the trade name Formex™ by Illinois Tool Works. Formex™ is the trade name for an extruded polypropylene which is supplied in (flat) sheet format as illustrated in FIG. 2; Typical sheet sizes are 2440 mm×1220 mm (8′×4′) and 1220 mm×1220 mm (4′×4′). Typically the material is lightweight (8′×4′ sheet=9.56 lbs, 4′×4′ sheet=4.78 lbs). Formex™ Panel is non-hydroscopic.

At least one slot 202 should be cut in the shroud 201, which corresponds to the position of a fuse 116. As the shroud 201 should preferably be fitted without the need to remove the fuses 116 and/or any fuse cover that might be present, using a slot 202 is most appropriate. Indeed, if the fuse covers remain in place, larger apertures may be required which may increase exposure/reduce the area shrouded. If only the fuse contacts 113; 121; 122 and 123 were present then apertures required would be much smaller. In any event, it is preferable that a slot 202 is dimensioned to be a close fit with the contacts and 123 so that the maximum shrouding is achieved.

An alternative arrangement is to provide the shroud 201 with one slot 202 or more slots 208 to 211 that run from one edge of the panel inwardly: the slot 202 opens out on one side of the panel and run to a desired point toward an opposite edge of the panel. In this arrangement the slot is arranged to be a sliding fit across both fuse contacts 114, 115 of a given pair—it acts as a receiver for the part. The sliding fit in this case is generally transverse to the longitudinal axis of the fuse contacts. This latter arrangement is particularly desirable as two or more pairs of fuse contacts may be arranged in a substantially linear configuration, such as pairs 121 to 123 in the example. In such a case a continuous slot can be arranged to slidingly fit over the substantially aligned pairs. Parallel slots 202 and 208 to 211 are provided for fitting over laterally spaced apart contact pairs (fuse links) 112 and 117 to 120.

In the example, four additional slots 208 to 211 are therefore cut, to allow the panel 201 to be slotted behind said fuse contacts 114, 115, i.e. fuse contacts of fuse links 112 and 117 to 120.

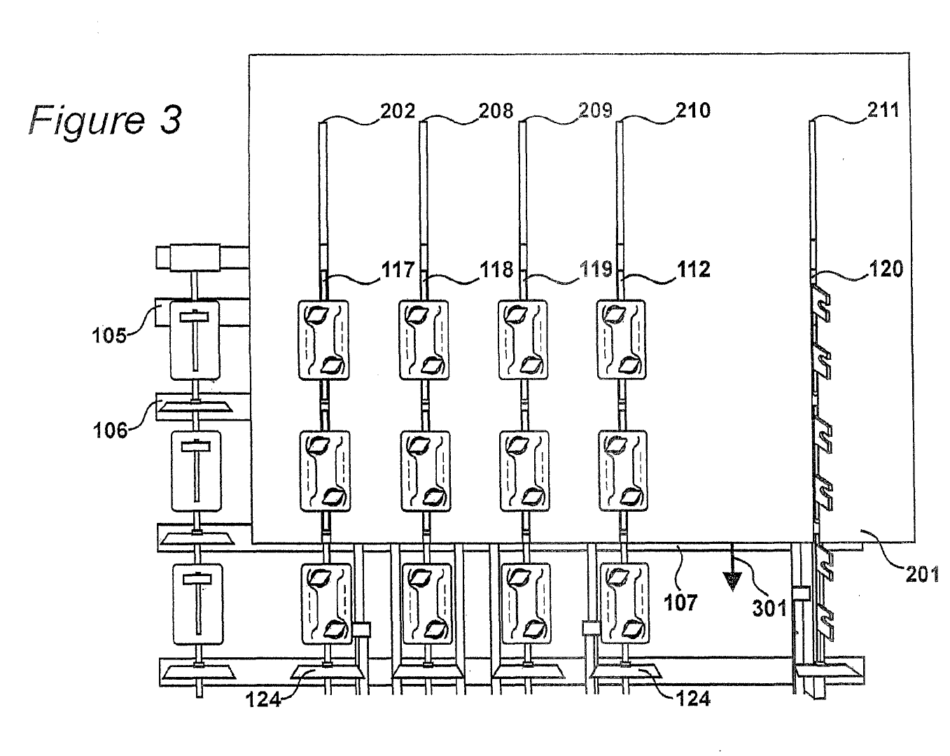

The shroud 201 of FIG. 2 is shown being slidingly fitted to cover the busbars 105 to 108 in FIG. 3.

It is preferable to remove all but the bottom row of flash guards 124 prior to slidingly fitting the slotted back panel 201, using insulated, approved tools and procedures, such that said panel 201 may rest on said last row even if it is not configured to self-stand or self-support.

The sheet or panel 201 is supported by being fitted over (301) the fuse contacts. Slots 202 and 208 to 211 are preferably lined up with fuse links 112 and 117 to 120, then the panel 201 is lowered, whereby only the outer free ends 114; 115 of the respective fuse contacts (connected or not by a fuse 116 of said fuse links 112 and 117 to 120) protrude from said shroud 201 and inner proximate panel components (104 to 112 and 117 to 120) are isolated behind said shroud 201.

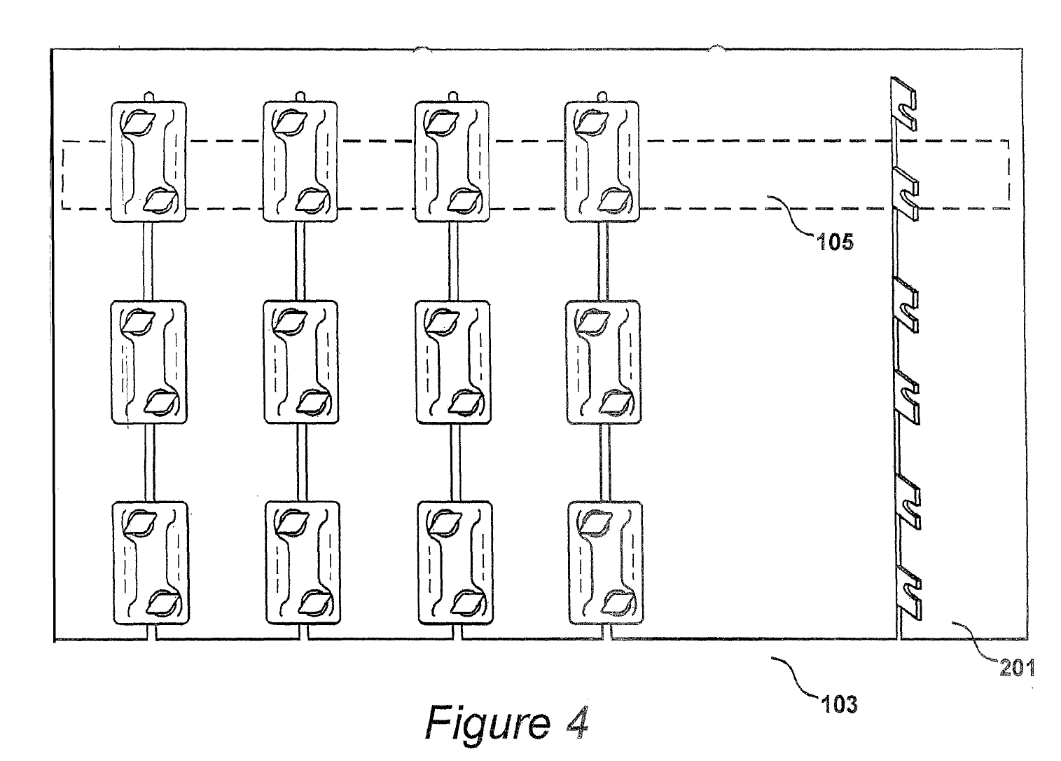

With reference now to FIG. 4, wherein shroud 201 has been fully lowered over support 104 and the inner panel components attached thereto, said shroud 201 will remain in place without the necessity for further fixings, so it is self-supporting. It could however be arranged to sit on the busbars 105 to 108, if required. It can be considered a sliding fit to the distribution system. In the example, busbars 105 to 108 are horizontally arrayed along the supporting wall 103, therefore the shroud 201 is arranged to stand in a substantially upright position, substantially parallel to support 103. Insulation is obtained according to the present invention.

One particular advantage shown in FIG. 4 is that such the slots 202 and 208 to 211 can typically be quite narrow and can be dimensioned to be quite small so that unintended contact with any components 105 to 123 by the physical barrier provided by the shroud barrier 201 is quite difficult. In particular the slots may be sufficiently small to prevent access of a body part, such as a digit, through the slot to the obstructed components.

Another particularly important advantage is that a panel 201 which has a slot 202 which runs inward from its edge (as described above) can be slid into place while a fuse 116 and/or fuse cover is in place. This means that the fuse 116 does not need to be removed which in turn means that the electricity supply 101, 102 across the fuse contacts need not be interrupted for fitting of the shroud 201.

Furthermore, once this initial panel 201 is in place, the danger of receiving an accidental shock is already greatly reduced, though the safety can be further improved as described below.

It is however not possible to re-attach flash guards 124, whereby the inherent danger posed by possible electric arcs developing between fuse contacts remains. In particular arcing of electrical current between adjacent current carrying elements is one of the most dangerous aspects of breaking of a high voltage current (for example by removal of a component). For example where a fuse 116 is removed (utilising its fuse cover) from between its fuse contacts ends 114, 115, arcing may occur from (one or both of the pair of) the now exposed fused contacts to other parts of the system, and in particular other adjacent fuse contacts such as those at 121.

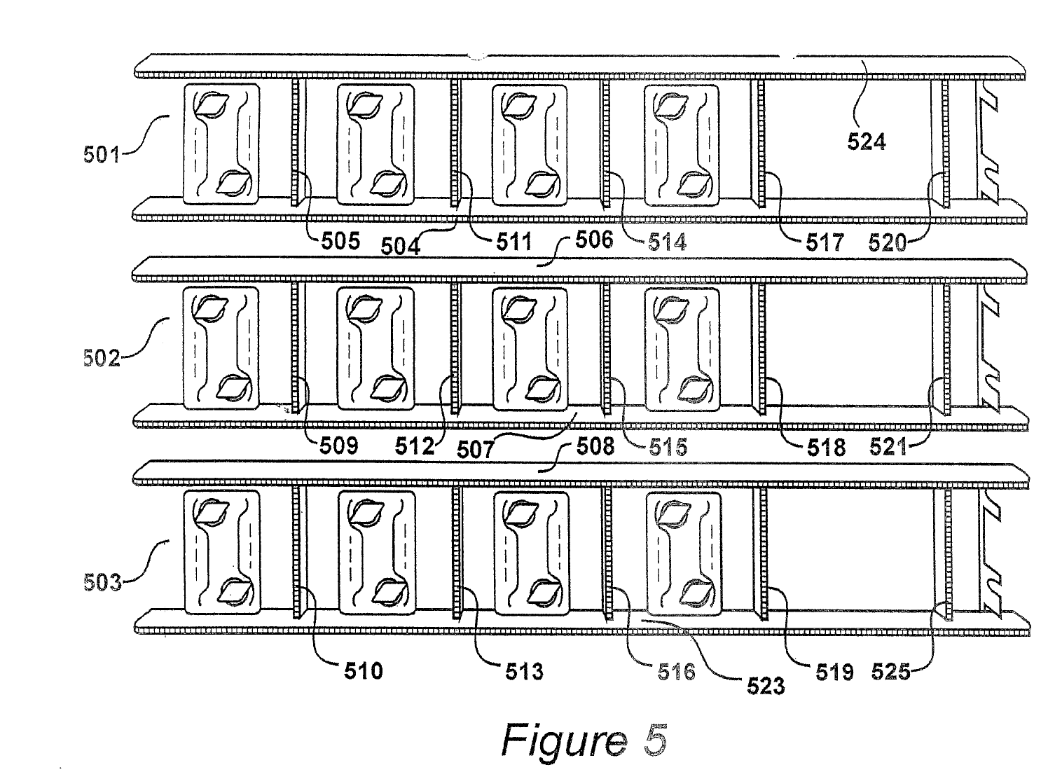

This problem is overcome in an alternative embodiment of the present invention shown in FIG. 5, wherein the isolation achieved in FIG. 4 is further improved with the configuration of the base shroud 201 with flash guards of the same material. The sheet 201 is of sufficiently rigid support to allow other elements, such as said flash guards, forming part of the shroud to be supported by it. Preferably, the surface of shroud 201 is prepared for said configuration with the removal of heavy deposits of dirt or grease from the preparing and/or fitting operation shown in FIGS. 2 to 4. Portions of the material shown in FIG. 2 are cut to size, preferably according to the possibilities for arcing presented by a particular distribution system.

In particular, where the pairs of fuse contacts are arranged in one or more rows 501 to 503, as in the example, it is desirable to provide an elongate flash guard element 504 which is attached to the sheet 201 and runs between those rows. Each row may be provided on a single busbar 105 or alternatively across adjacent busbars 105 to 108. Where an array 120 of pairs 121 to 123 of fuse contacts are provided, it is desirable to provide flash guards which form a barrier to arcing from any given pair of fuse contacts to all adjacent pairs of fuse contacts. In particular, it is desirable to provide flash guards which act to provide a barrier in all directions about any given pair of fuse contacts.

In the present embodiment, the moulded two-part fastening product sold by 3M under the product name Dual Lock™ is used to secure elongate flash guards shown in FIG. 5. In this respect any further given pieces can be fixed to the support or substrate, or to other parts of the shroud 201 simply and easily. At least two flash guards 504, 505 are provided, which run transversely to each other and are arranged so as to prevent arcing as between pairs of fuse contacts which are adjacent to a given row 501 or a column.

Moreover, a skilled person will appreciate however, that if two or more elongate flash guards 501, 502 are used in a generally parallel arrangement to separate one column from another or one row from another, it may then be more practical to use a series of shorter flash guards to run between and transverse to the elongate flash guards. In the example, twelve pairs of fuse contacts are arranged in a matrix of rows and columns, and so elongate flash guards 504, 506, 507 and 508 and flash guards 509 to 522 are fixed to the panel 201 by means of said two-part fastening product. As an added security measure, elongate flash guards 523 and 524 are then fixed at the upper and lower periphery of the matrix to further prevent accidental contact.

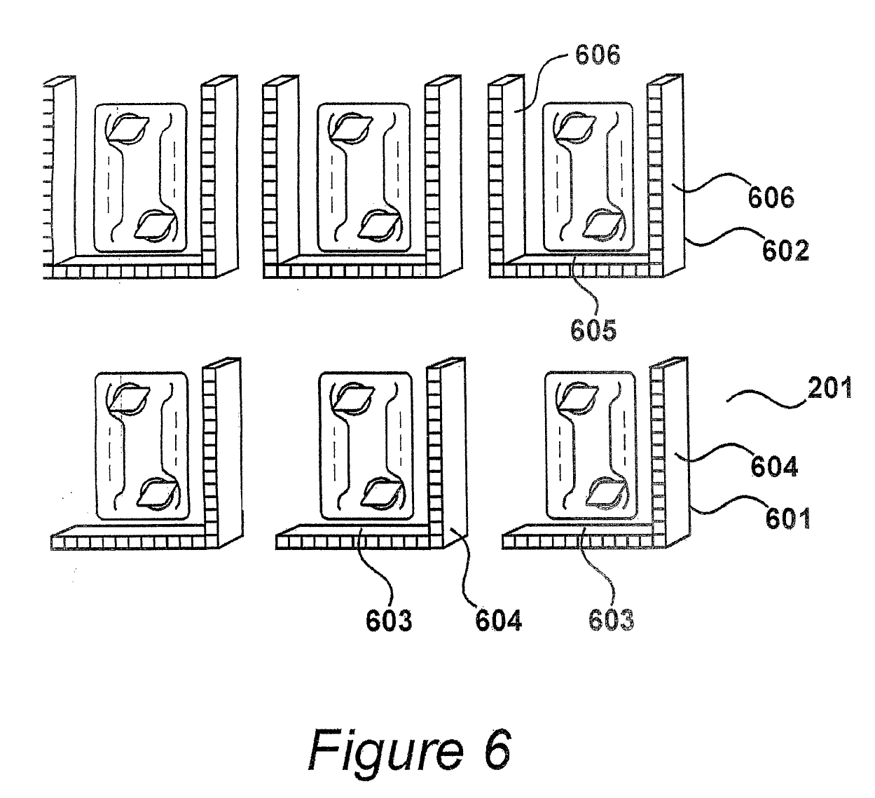

Another alternative embodiment of the present intervention is shown in FIG. 6, wherein the flash guards 504 to 524 of FIG. 5 have an alternative configuration. It will be appreciated that the flash guards of the invention may be integrally formed with the support sheet 201. However again, in particular for ease of retrofitting, it is desirable that the flash guards are fitted after the sheet 201 has been applied (301). Again this may be done in a live environment without high risk.

In general the flash guards may be provided (see FIG. 6) in a substantially L-shaped (601) or U-shaped (602) form. In the substantially L-shaped form 601 the flash guard can be attached to the sheet 201 by one limb 603 of the L-shape while the other limb 604 acts to provide a barrier against arcing. In a generally U-shaped form 602, the bridging portion 605 (the bottom portion) of the U-shape can be employed to attach the flash barrier to the sheet. The opposing, upstanding limbs of the U-shape, on the bridging portion, can each form a barrier 606 against arcing, effectively then a double flash guard.

With respect to fuse link 120 and the absence of fuses 116 attached to the fuse contacts thereof, the isolation provided by the shroud 201 of the present invention, even when further configured with any or a combination of flash guards 504 to 606 according of the alternative embodiment, is insufficient to cancel the danger posed by the live contacts of pairs 121 to 123 respectively connected to busbars 105 to 108.

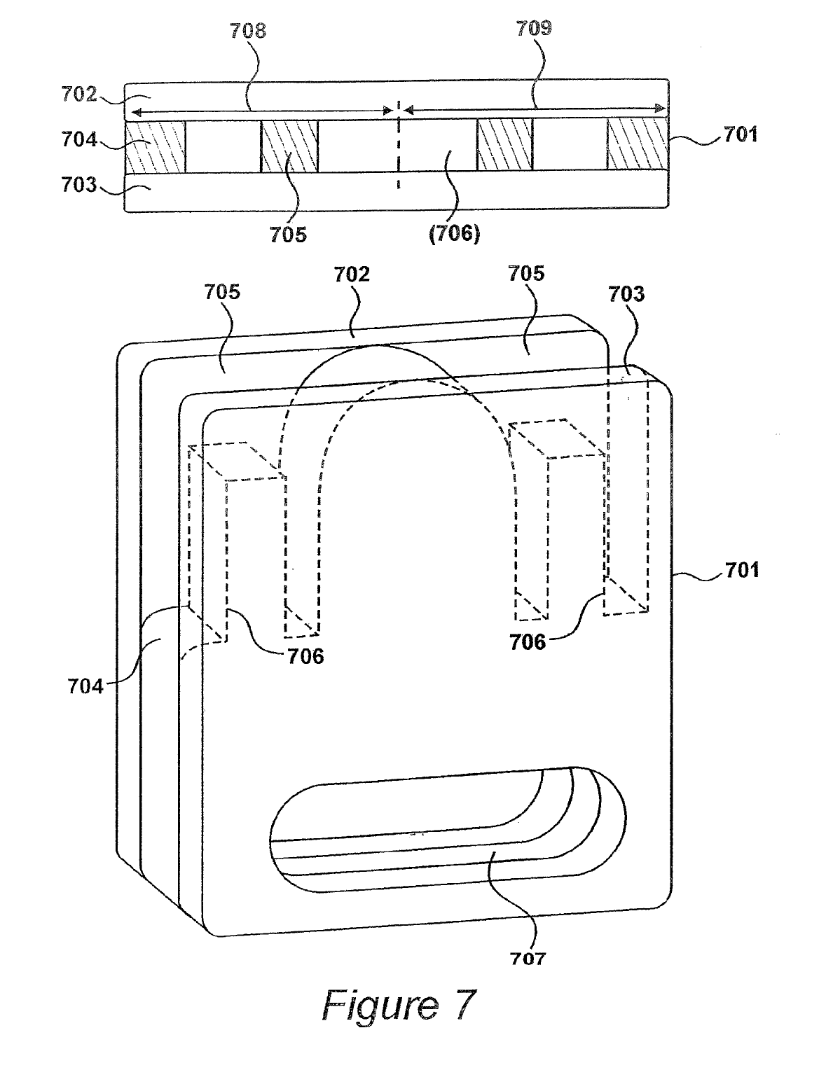

FIG. 7 shows an electrical fuse contact cover 701, provided in an alternative embodiment of the present invention, for at least one pair of spaced apart fuse contacts each contact having a free end 114; 115 and the free end thereof arranged to receive a fuse 116, the cover 701 having a body constructed of an insulating material 201 with opposing side walls 702, 703 held in a spaced apart arrangement by an internal insulating spacer 704, the walls 702, 703 forming a housing with a mouth 705 therein, for the fuse contacts 114, 115 and the side walls 702, 703 being adapted to resiliently deform and grip the fuse contacts 114, 115, and the spacer 704 being profiled (706) to extend about the free ends of the fuse contacts, when the cover 701 is placed over the fuse contacts 114, 115 and the contacts 114, 115 are in the housing 706.

Desirably the contact cover 701 comprises a handle portion 707 for ease of handling. Desirably the side-walls 702, 703 are profiled (706) to form resiliently deformable jaws 708, 709 which act together to provide the gripping action. In this respect the mouth may be formed by the arrangement of the side-walls and for example lack any interconnection between the side walls about the mouth. The side-walls 702, 703 will generally be arranged to sufficiently close any gap between them to the sides of the mouth to prevent any unintentional contact with the fuse contacts 114, 115

The spacer 704 and the side walls 702, 703 may all be made of separate pieces or integrally formed. The fuse contact cover 701 may also form part of a shroud 201 of the present invention and is suitably fitted over a given pair 121 of fuse contacts 114, 115 when the sheet 201 is already in place.

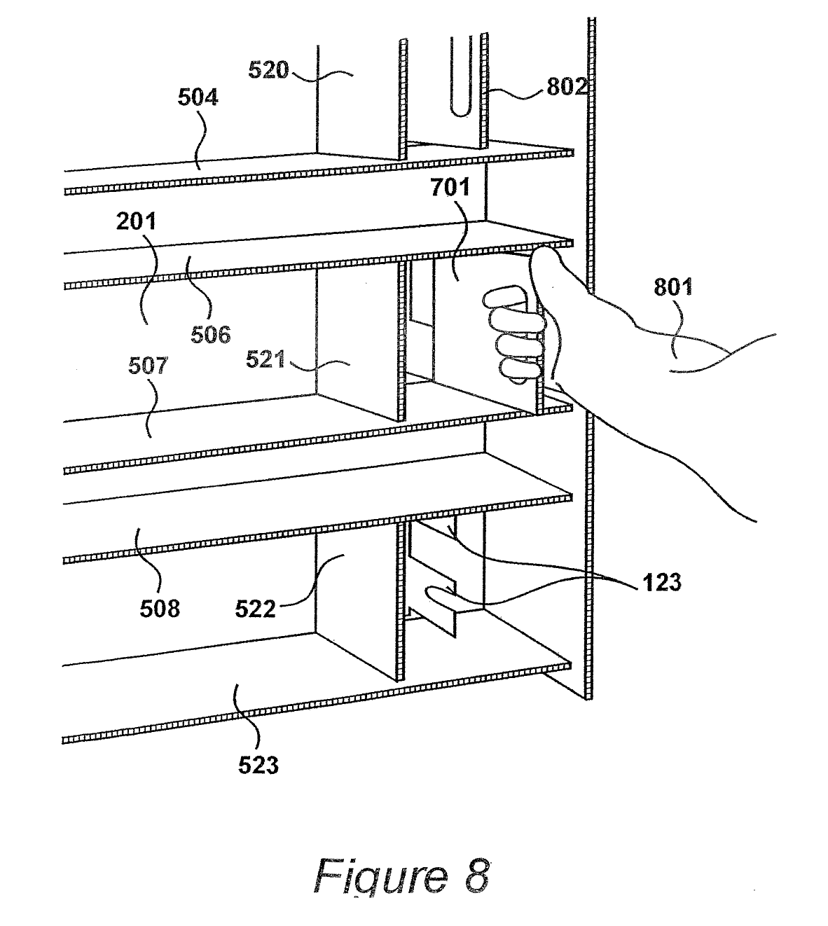

The placing of the cover 701 over fuse contacts 121 according to the above embodiment is shown in FIG. 8, wherein a user 801 may easily fit a single, slide-on cover 701 which can adequately protect any given pair of exposed fuse links ends 114, 115. A second cover 802 is shown in place protecting the pair of previously-exposed fuse links 114, 115 of pair 121, whilst the pair of still-exposed fuse links 114, 115 of pair 123 shall be similarly covered, whereby nearly all of the component parts of the distribution system are now isolated and made safe.

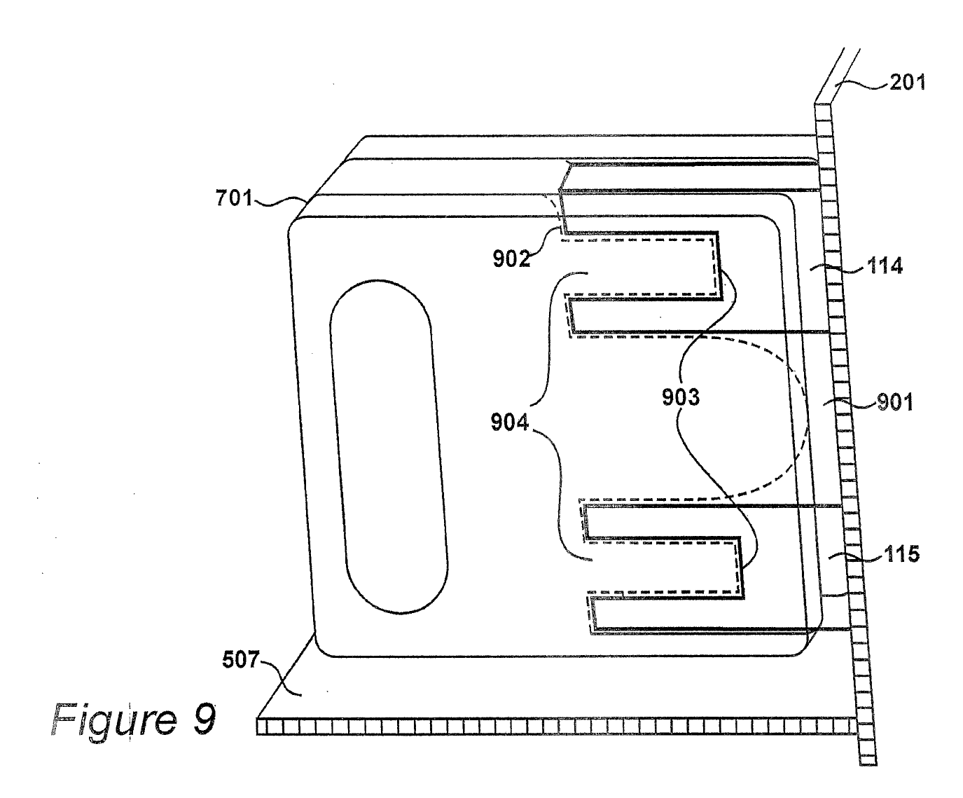

A diagrammatic representation of the electrical fuse contact cover 701 is shown in place over fuse contacts 114, 115 in further detail in FIG. 9. It was previously stated that it is desirable that the spacer 701 extends into the space 901 between contacts 114, 115. This provides for a better fit to the contacts. Alternatively or additionally the spacer 701 may mate (902) with the free ends of the fuse contacts. For example the spacer 701 may extend into the space between the pair of free ends. Alternative or additionally if the free ends each have a fuse receiving recess 903, as they typically have, the spacer may extend into any one or all of those recesses 903.

Mating is however not to be considered a close profile mating fit, as shown in the example, as it is desirable to provide a contact cover that can fit similarly but not identically dimensioned fuse contacts 121 which also may have variations on shape. In this respect extension of a male part 904 on the spacer into a recess 903 formed in, or a space 901 between the fuse contacts, is considered sufficient for the purposes of the invention.

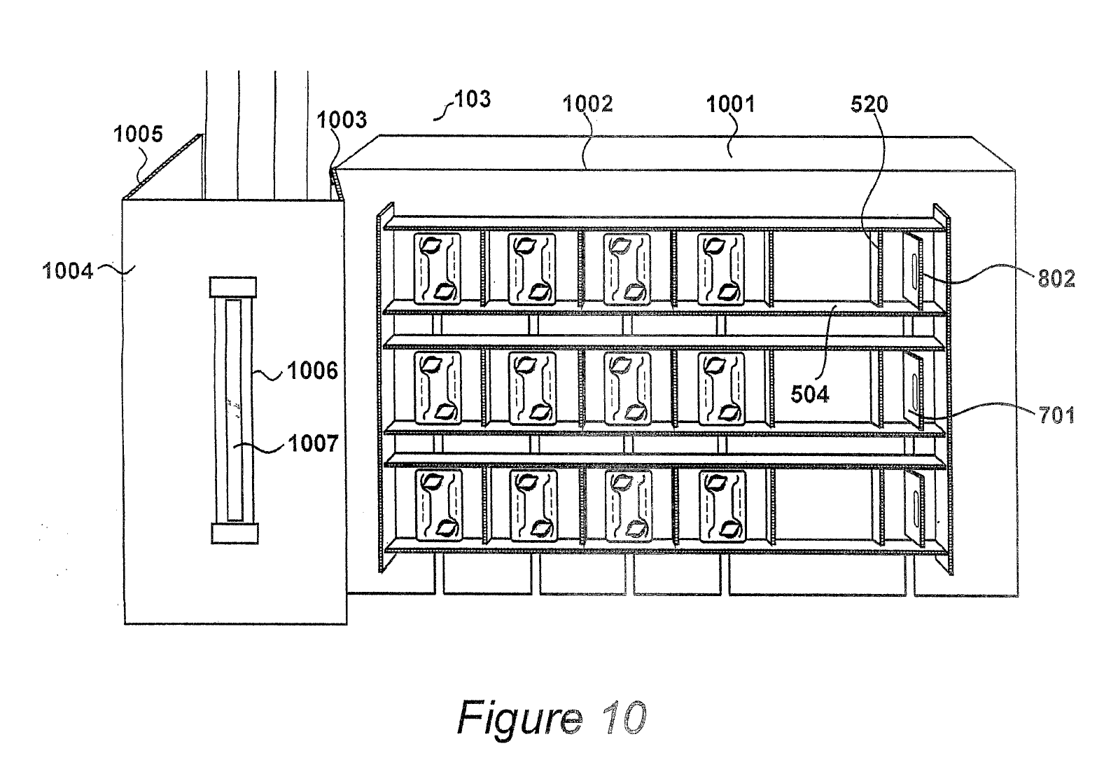

Another embodiment of the present invention is shown in FIG. 10, wherein the shroud barrier 201 with a rear guard 1001. The rear guard 1001 on the sheet 201 may be provided by forming a score-line proximate an appropriate edge 1002 on the sheet 201 at the appropriate point to create a hinged rear guard portion 1001 and folding back the so-formed rear guard portion 1001 formed by creating the score line 1002. It will also be appreciated that any number of scores may be provided at desired points in the material so that L-shape 601 and U-shape 602 pieces can also be easily constructed. In particular, such as with the rear guard portion 1001, a further folding piece, may be provided and arranged to as to fold in an arrangement where a side wall 1003 of the material can be arranged substantially parallel to the support 103 or substrate for fixing thereto. The material described in FIG. 2 may also be partially cut (scored) so that it may be easily folded. For example a cut (score) may be made through one side wall 205 and possibly a portion of transverse members 206 so that the material can be folded about a fold line 1002 on the other side wall 204. It has been found that cutting in a direction across the transverse members 206, therefore perpendicular to length 207, gives a sharper cut. Of course the material may also be cut into separate pieces as required. In this respect, the sheet can be considered as oversized in that it will be sized to extend beyond the perimeter of the area to be protected.

Generally, the rear guard 1001 is representative of the need to further protect against access from any side (including where appropriate top and base ends) behind the shroud 201, for example by insertion of a body part such as the hand/digit, or an implement into any space remaining between the shroud and the underlying components 105 to 123. The rear guard 1001 therefore extends sufficiently proximate to the wall 103 to prevent any such access. In the example, the rear guards 1001, 1003 are formed on the sheet 201 and are formed by bending one or more portions of the sheet toward said wall 103.

Further elements such as a cover portion 1004 may be provided, for example to cover over the switches 109 to 111, which are the last component parts not yet insulated. Said cover 1004 is fixed to the existing part 1003 of the shroud 201 in any of the ways described above, for example by providing said side member 1003 between the cover 1004 and the existing shroud 201, attaching the cover portion 1004 to one or more of the sheet 201 or one or more of the flash guards 505 or even a new shroud 1005.

Furthermore the cover 1004 may be provided with one or more window apertures 1006, which may be located as desired in any part of the shroud. A substantially transparent window panel 1007, also constructed of sufficiently impact resistant material (preferably plastics material) may be provided to cover any given aperture 1006, and should preferably be applied to the outside of said aperture 1006. It is desirable that the window is of substantially sufficient dimensions to prevent access, for example, by insertion of body parts such as the hand. The cover 1004 and/or the window panel 1006, 1007 may be attached in the manner described above. In this way the shroud 201 can be built up as desired to form a housing for the entire arrangement to be covered. A cabinet type structure can be created in a retrofitting scenario.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment, Conversely, various features of the invention which are, for brevity, described in the context of a single embodiment, may also be provided separately or in any suitable sub-combination.

1. A shroud barrier for shrouding an electricity distribution system mounted on a substrate:
the system comprising:
(i) a support for supporting an electrical distribution panel on a substrate;
(ii) an electrical distribution panel on the support, the distribution panel comprising:
at least one busbar arranged on the support;
at least one pair of spaced apart fuse contacts each having a free end, the free ends thereof adapted to receive a fuse, one fuse contact connected to the busbar and the other connected to an outlet point, the fuse contacts arranged so that the free ends thereof hold the fuse away from the busbar;
the shroud barrier comprising a sheet of insulating material slotted so as to slidingly fit across the fuse contacts, and dimensioned to cover the busbar and the support, so that substantially only the free ends of the fuse contacts extend through the slot.

2. A shroud barrier according to claim 1 which is self-supporting on the support or the panel.

3. A shroud barrier according to claim 1 or claim 2 wherein the slot(s) are dimensioned to be a close fit with the contacts.

4. A shroud barrier according to claim 1 wherein the sheet is provided with one or more slots that run from one edge of the sheet inwardly.

5. A shroud barrier according to claim 1 wherein two or more pairs of fuse contacts are arranged in a substantially aligned configuration and a continuous slot is arranged to slidingly fit over the substantially aligned pairs.

6. A shroud barrier according to claim 1 wherein the sheet is adapted to slide into place when a fuse and/or fuse cover is positioned on said at least one pair of fuse contacts.

7. A shroud barrier according to claim 1 wherein the sheet has a thickness of from about 5 to about 7 mm.

8. A shroud barrier according to claim 1 further comprising at least one flash guard arranged to prevent arcing between adjacent current carrying elements of the system.

9. A shroud barrier according to claim 8 wherein at least one flash guard is provided between pairs of fuse contacts on a given busbar or on adjacent busbars.

10. A shroud barrier according to claim 9 wherein four or more pairs of fuse contacts are arranged in at least two rows each on adjacent busbars, and an elongate flash guard element which is attached to the sheet is provided and runs between those rows.

11. A shroud barrier according to claim 10 wherein an array of pairs of fuse contacts are provided and a plurality of flash guards are provided to form a barrier to arcing from any given pair of fuse contacts to all adjacent pairs of fuse contacts.

12. A shroud barrier according to claim 8 wherein the flash guard(s) is (are) provided in a substantially L-shaped or U-shaped form.

13. A shroud barrier according to claim 1 further comprising one or more rear guards which extend from the shroud towards the support to prevent access to elements of the distribution panel which are shrouded by the sheet.

14. A shroud barrier according to claim 13 wherein the rear guard(s) are formed by bending one or more portions of the sheet.

15. A shroud barrier according to claim 1 wherein the sheet is constructed of a material having opposing side walls, the opposing side walls being connected by a series of (spaced apart) transverse member.

16. A shroud barrier according to claim 15 wherein the material is an extruded material.

17. A shroud barrier according to claim 1 which is provided with one or more window apertures.

18. A shroud barrier according to claim 17 wherein a substantially transparent window panel is provided across the aperture(s).

19. A method of shrouding an electricity distribution system having a construction according to claim 1, comprising the steps of:
(iii) providing a shroud barrier comprising a sheet of insulating material slotted so as to slidingly fit across the fuse contacts, and dimensioned to cover the busbar and the support; and
(iv) fitting the barrier over the fuse contacts so that substantially only the free ends of the fuse contacts extend through the slot.

20. A method according to claim 19 further including the step of:
fitting one or more flash guards to prevent arcing between adjacent current carrying elements of the system.

21. A method according to claim 19 comprising the step of providing one or more rear guards which extend from the shroud towards the support to prevent access to elements of the distribution panel which are shrouded by the sheet.

22. A method according to claim 21 wherein the rear guard(s) is (are) provided by bending one or more portions of the sheet.

23. A kit for assembling a shroud barrier according to claim 1 comprising:
(iii) a shroud barrier comprising a sheet of insulating material slotted so as to slidingly fit across the fuse contacts, and dimensioned to cover the busbar and the support; and
(iv) two-part fastening means for fixing the barrier to at least one of the support, the distribution panel or the substrate.

24. A kit according to claim 23 further comprising one or more flash guards for preventing arcing between adjacent current carrying elements of the system.

25. A kit according to claim 23 further including one or more rear guards.

26. An electrical fuse contact cover for at least one pair of spaced apart fuse contacts each contact having a free end the free ends thereof arranged to receive a fuse, the cover having a body constructed of an insulating material with opposing side walls held in a spaced apart arrangement by an internal insulating spacer,
the walls forming a housing with a mouth therein, for the fuse contacts and the side walls being adapted to resiliently deform and grip the fuse contacts, and the spacer being profiled to extend about the free ends of the fuse contacts, when the cover is placed over the fuse contacts and the contacts are in the housing.

27. An electrical fuse contact cover according to claim 26 wherein the spacer extends into the space between contacts.

28. An electrical fuse contact cover according to claim 26 which mates with the free ends of the fuse contacts.

29. An electrical fuse contact cover according to claim 26 further comprising a handle portion.

30. (canceled)
